(19) United States
(12) Patent Application Publication
(10) Pub. No.: US 2014/0110182 A1
(43) Pub. Date: Apr. 24, 2014

(54) LAWN CARE VEHICLE ADJUSTABLE STEERING ASSEMBLY

(71) Applicant: Sean Dwyer, Gastonia, NC (US)

(72) Inventor: Sean Dwyer, Gastonia, NC (US)

(73) Assignee: HUSQVARNA CONSUMER OUTDOOR PRODUCTS N.A., INC., Charlotte, NC (US)

(21) Appl. No.: 14/127,381

(22) PCT Filed: Jun. 29, 2011
(86) PCT No.: PCT/US11/42306

§ 371 Date: Dec. 18, 2013

(51) Int. Cl. A01D 34/82; B62D 11/02; B62D 1/12

(52) U.S. Cl. CPC A01D 34/824; B62D 1/12; B62D 11/02
USPC 180/6.2; 74/522

(57) ABSTRACT

A riding lawn care vehicle may include a frame and a steering assembly. Wheels of the riding lawn care vehicle may be attachable to the frame. The steering assembly may be operably coupled to at least two drive wheels of the riding lawn care vehicle to facilitate turning of the riding lawn care vehicle based on drive speed control of the at least two drive wheels responsive to positioning of steering levers of the steering assembly. The steering assembly may include a vertical adjustment assembly configured to enable telescopic adjustment of a height of a corresponding one of the steering levers.

### TECHNICAL FIELD

Example embodiments generally relate to lawn care vehicles and, more particularly, relate to an adjustable steering assembly for vehicles configured for performing lawn maintenance.

### BACKGROUND

Lawn care tasks are commonly performed using various tools and/or machines that are configured for the performance of corresponding specific tasks. Certain tasks, like grass cutting, are typically performed by lawn mowers. Lawn mowers themselves may have many different configurations to support the needs and budgets of consumers. Walk-behind lawn mowers are typically compact, have comparatively small engines (e.g., less than 200 cubic centimeters (cc)) and are relatively inexpensive. Meanwhile, at the other end of the spectrum, riding lawn mowers, such as lawn tractors, can be quite large and sometimes have engines exceeding 400 cc. Riding lawn mowers can sometimes also be configured with various functional accessories (e.g., trailers, tillers and/or the like) in addition to grass cutting components. Riding lawn mowers provide the convenience of a riding vehicle as well as a typically larger cutting deck as compared to a walk-behind model.

By their very nature, riding lawn mowers include steering assemblies that are used to direct the movement of the riding lawn mowers. The steering assemblies often take the familiar form of a steering wheel. However, handlebar assemblies have also been used in some cases. More recently, some zero turn mowers have employed separate steering levers or even a joystick to provide steering functionality. There are clearly a number of steering assembly options from which to choose when an operator considers purchasing a riding lawn mower. However, once a choice is made with respect to a particular machine and its respective steering assembly, adjustment options may be somewhat limited.

### BRIEF SUMMARY OF SOME EXAMPLES

Accordingly, in order to improve operator comfort, some example embodiments may provide an adjustable steering assembly for use on a lawn care vehicle. Such an adjustable steering assembly may enable operators to make steering assembly adjustments to positively impact user experience in relation to comfort and ease of operation when utilizing a lawn care vehicle employing, for example, steering levers that are commonly employed on zero turn radius (ZTR) mowers. In this regard, the steering levers of an example embodiment may be affixable to the lawn care vehicle via quick adjust fittings to allow the height and/or orientation of the steering levers to be adjusted easily by the operator. Furthermore, in some embodiments the steering levers may have a bend inserted along a longitudinal length thereof in order to provide an orientation bias either toward or away from the user dependent upon how the steering levers are inserted into the respective quick adjust fittings. In some cases, the adjustable steering assembly may enable the lawn care vehicle to take up less space and/or subject the steering assembly to less risk of abnormal stress when the lawn care vehicle is being stored or shipped by reducing the overall lawn care vehicle profile when the steering levers are removed or positioned in a way that makes the profile more compact.

In one example embodiment, a riding lawn care vehicle is provided. The riding lawn care may include a frame and a steering assembly. Wheels of the riding lawn care vehicle may be attachable to the frame. The steering assembly may be operably coupled to at least two drive wheels of the riding lawn care vehicle to facilitate turning of the riding lawn care vehicle based on drive speed control of the at least two drive wheels responsive to positioning of steering levers of the steering assembly. The steering assembly may include a vertical adjustment assembly configured to enable telescopic adjustment of a height of a corresponding one of the steering levers.

In another example embodiment, an adjustable steering assembly for employment on a riding lawn care vehicle is provided. The adjustable steering assembly may include a pair of independently operable steering levers and a corresponding pair of base bars. The corresponding pair of base bars may be operably coupled to respective ones of the steering levers and may be operably coupled to respective ones of at least two drive wheels of the riding lawn care vehicle to facilitate turning of the riding lawn care vehicle based on drive speed control of the at least two drive wheels responsive to positioning of the steering levers. Each one of the steering levers may include a vertical adjustment assembly configured to enable telescopic adjustment of a height of a corresponding one of the steering levers.

Some example embodiments may improve an operator's ability to manipulate the position of the steering assembly of a lawn care vehicle. The user experience associated with achieving a comfortable ride on a riding lawn care vehicle may therefore be improved.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A illustrates a perspective view of a riding lawn care vehicle according to an example embodiment;

FIG. 1B illustrates a top view of the riding lawn care vehicle according to an example embodiment;

FIG. 2 illustrates a perspective view of a steering assembly with steering levers being pulled back for rearward propulsion according to an example embodiment;

FIG. 3 illustrates a perspective view of a vertical adjustment assembly according to an example embodiment;

FIG. 4, which includes FIGS. 4A and 4B, illustrates two perspective views of the steering levers to illustrate the bent nature of the steering levers that facilitates lever swapping to provide easy adjustment of the distance from the steering levers to the operator according to an example embodiment;

FIG. 5A illustrates a perspective view of a lowered-first steering lever positioning option where a shaft bend is oriented to direct handles toward an operator, and a bottom portion of a lever shaft is substantially fully inserted into a base bar and the vertical adjustment assembly according to an example embodiment;

FIG. 5B illustrates a perspective view of an elevated-first steering lever positioning option where the shaft bend still directs the handles toward the operator, but the bottom portion is extended to provide a higher handle elevation according to an example embodiment;

FIG. 5C illustrates a perspective view of a lowered-second steering lever positioning option where the shaft bend is oriented to direct the handles away from the operator, and the bottom portion is substantially fully inserted into the base bar and the vertical adjustment assembly according to an example embodiment;

FIG. 5D illustrates a perspective view of an elevated-second steering lever positioning option where the shaft bend still directs the handles away from the operator, but the bottom portion is extended to provide a higher handle elevation according to an example embodiment; and

FIG. 6, which includes FIGS. 6A and 6B, illustrates two perspective views of a vertical adjustment assembly according to an alternative example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments may improve operator comfort for operators of lawn care vehicles such as, for example, riding lawn mowers. In this regard, some example embodiments may provide an adjustable steering assembly for use on a lawn care vehicle. Such an adjustable steering assembly may enable operators to make steering assembly adjustments in relation to the height of the steering assembly. In some embodiments, the steering assembly may be provided in the form of steering levers for a zero turn radius mower, where the steering levers have a telescoping or collapsible shaft to enable the zero turn radius mower steering levers to be adjusted to a height that is comfortable for the user. The steering levers may each collapse into a corresponding mounting receptacle configured to releasably engage the respective steering levers. Furthermore, in some example embodiments, the steering levers may have a bend along a longitudinal length thereof so that a distance of at least a portion of the steering levers from the operator may be adjusted based on which steering lever is paired with a respective mounting receptacle. Moreover, in some embodiments, the steering levers may be rotated within their respective mounting receptacles in order to further customize the orientation thereof.

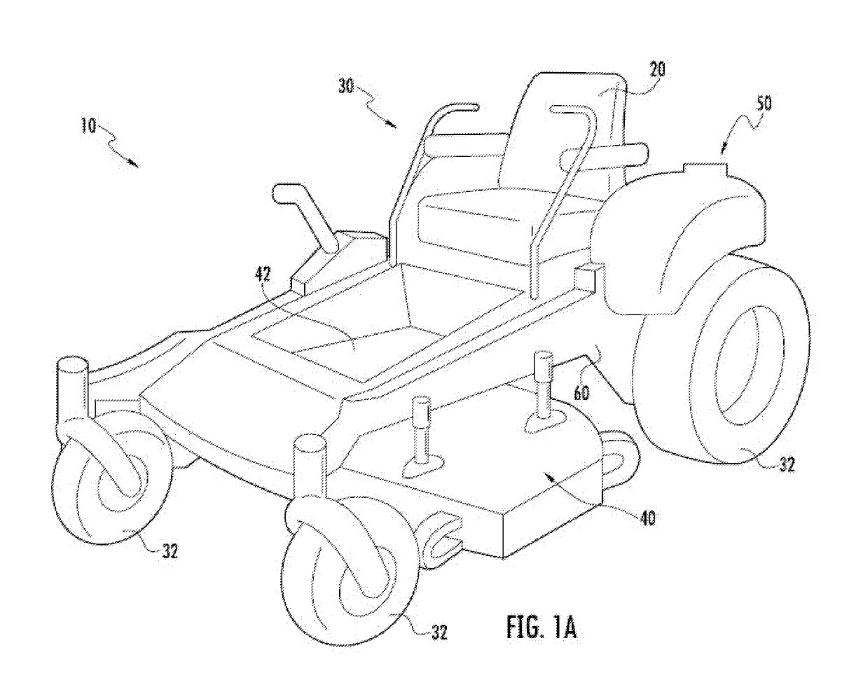

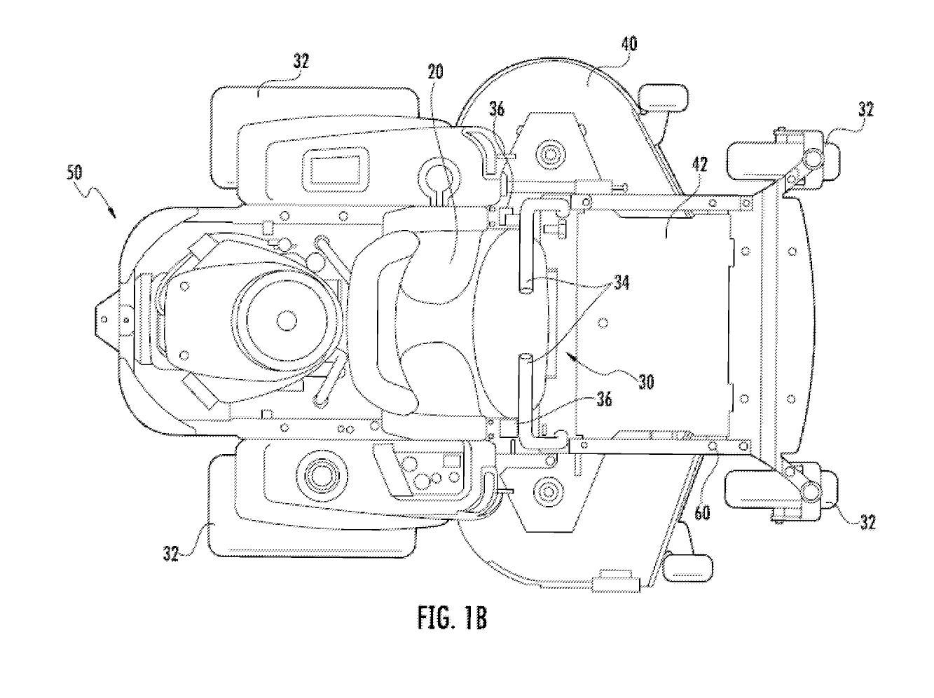

FIG. 1, which includes FIGS. 1A and 1B, illustrates a riding lawn care vehicle 10 having an adjustable steering assembly according to an example embodiment. FIG. 1A illustrates a perspective view of the riding lawn care vehicle 10 and FIG. 1B illustrates a top view of the riding lawn care vehicle 10 according to an example embodiment. In some embodiments, the riding lawn care vehicle 10 may include seat 20 that may be disposed at a center, rear or front portion of the riding lawn care vehicle 10. The riding lawn care vehicle 10 may also include a steering assembly 30 (e.g., a set of zero turn mower steering levers, or the like) functionally connected to wheels 32 of the riding lawn care vehicle 10 to allow the operator to steer the riding lawn care vehicle 10. The operator may sit on the seat 20, which may be disposed to the rear of the steering assembly 30 to provide input for steering of the riding lawn care vehicle 10 via the steering assembly 30. However, some models may be stand-up models that eliminate the seat 20. If the seat 20 is eliminated, the operator typically stands at an operator station proximate to the steering assembly 30.

In an example embodiment, the steering assembly 30 may be an adjustable steering assembly including separately adjustable steering levers 34 and a vertical adjustment assembly 36 for each of the steering levers 34. The adjustable steering assembly may provide operators with an ability to adjust the height of the steering levers 34 using the vertical adjustment assembly 36, to swap the steering levers 34, or to adjust the orientation of the steering levers 34 to modify a position and/or orientation of the steering levers 34 based on the desires of the operator for improved operator comfort and/or control while operating the riding lawn care vehicle 10.

The riding lawn care vehicle 10 may also include a cutting deck 40 having at least one cutting blade mounted therein. The cutting deck 40 may be positioned behind the front pair of wheels 32 in a position to enable the operator to cut grass using the cutting blade when the cutting blade is rotated below the cutting deck 40 when the cutting deck 40 is in a cutting position. However, in some alternative examples, the cutting deck 40 may be positioned in front of the front pair of wheels 32. In some embodiments, a footrest 42 may also be positioned above the cutting deck 40 forward of the seat 20 to enable the operator to rest his or her feet thereon while seated in the seat 20. In embodiments that do not include the seat 20, the footrest 42 may be the operator station from which a standing operator controls the riding lawn care vehicle 10. When operating to cut grass, the grass clippings may be captured by a collection system, mulched, or expelled from the cutting deck 40 via either a side discharge or a rear discharge.

In the pictured example embodiment, an engine 50 of the riding lawn care vehicle 10 is disposed to the rear of a seated operator. However, in other example embodiments, the engine 50 could be in different positions such as in front of or below the operator. As shown in FIG. 1, the engine 50 may be operably coupled to one or more of the wheels 32 to provide drive power for the riding lawn care vehicle 10. The engine 50, the steering assembly 30, the cutting deck 40, the seat 20 and other components of the riding lawn care vehicle 10 may be operably connected (directly or indirectly) to a frame 60 of the riding lawn care vehicle 10. The frame 60 may be a rigid structure configured to provide support, connectivity and interoperability functions for various ones of the components of the riding lawn care vehicle 10.

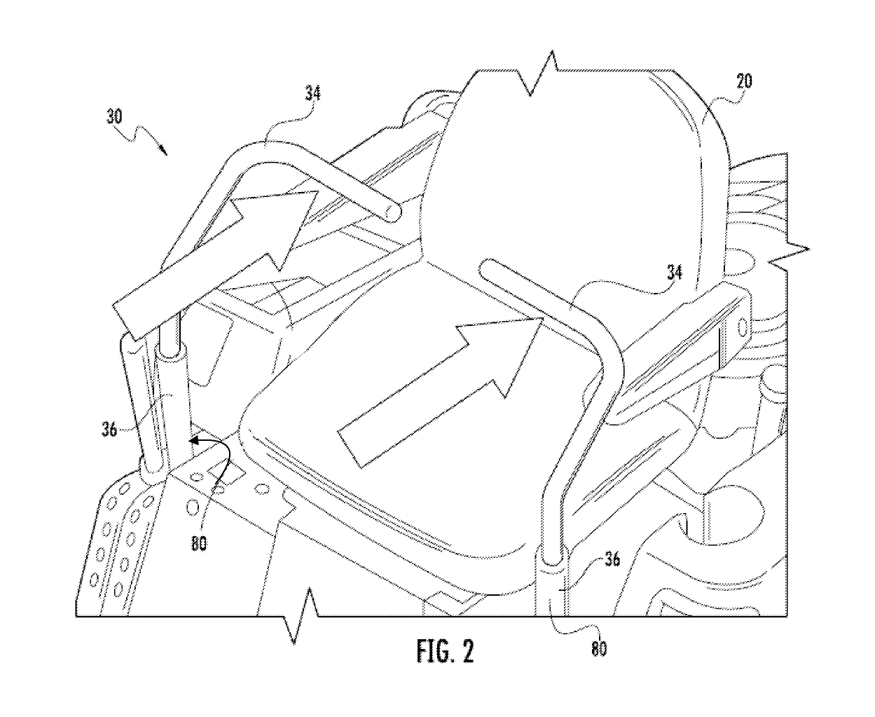

In some example embodiments, the steering assembly 30 may be embodied as an assembly of metallic or other rigid components that may be welded, bolted or otherwise attached to each other and operably coupled to the wheels 32 of the riding lawn care vehicle 10 to which steering inputs are provided. For example, the steering assembly 30 may include or otherwise be coupled with hydraulic motors that independently power drive wheels on each respective side of the riding lawn care vehicle 10. When a steering lever is pushed forward (e.g., away from the operator), the corresponding hydraulic motor may drive the corresponding wheel forward. When a steering lever is pulled backward (e.g., toward the operator as shown by the directional arrows in FIG. 2), the corresponding hydraulic motor may drive the corresponding wheel backward. Thus, when both steering levers are pushed forward the same amount, the riding lawn care vehicle 10 travels forward in substantially a straight line since approximately the same amount of forward drive input is provided to each drive wheel. When both steering levers are pulled back the same amount, the riding lawn care vehicle 10 travels backward in substantially a straight line since approximately the same amount of rearward drive input is provided to each drive wheel. When one steering lever is pushed forward and the other steering lever is pulled back, the riding lawn care vehicle 10 begins to turn in a circle. Steering right and left may be accomplished by providing uneven amounts of input to the steering levers. Other steering control systems may be employed in some alternative embodiments.

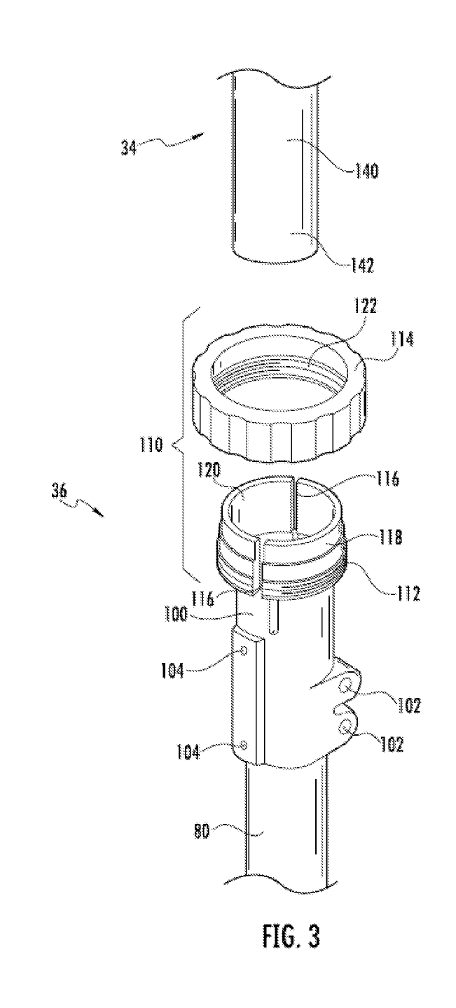

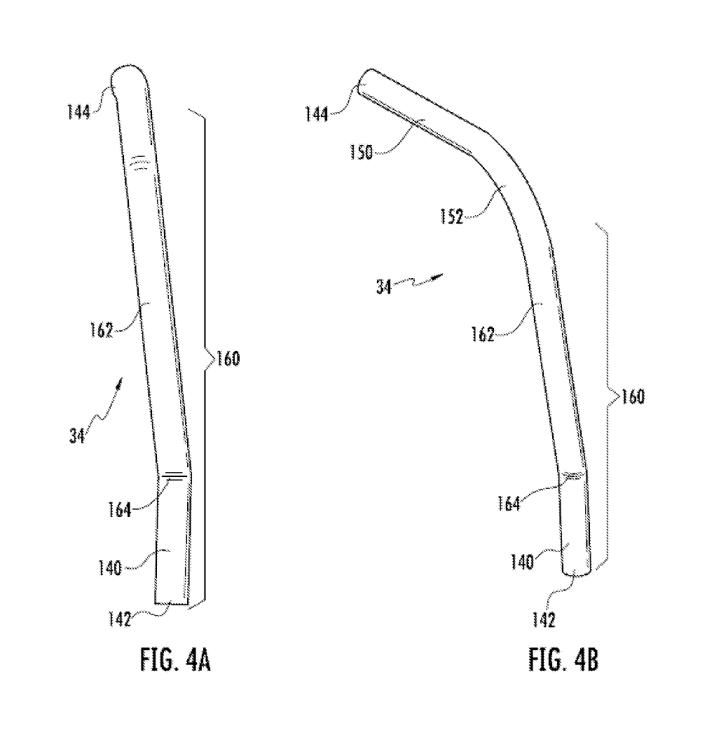

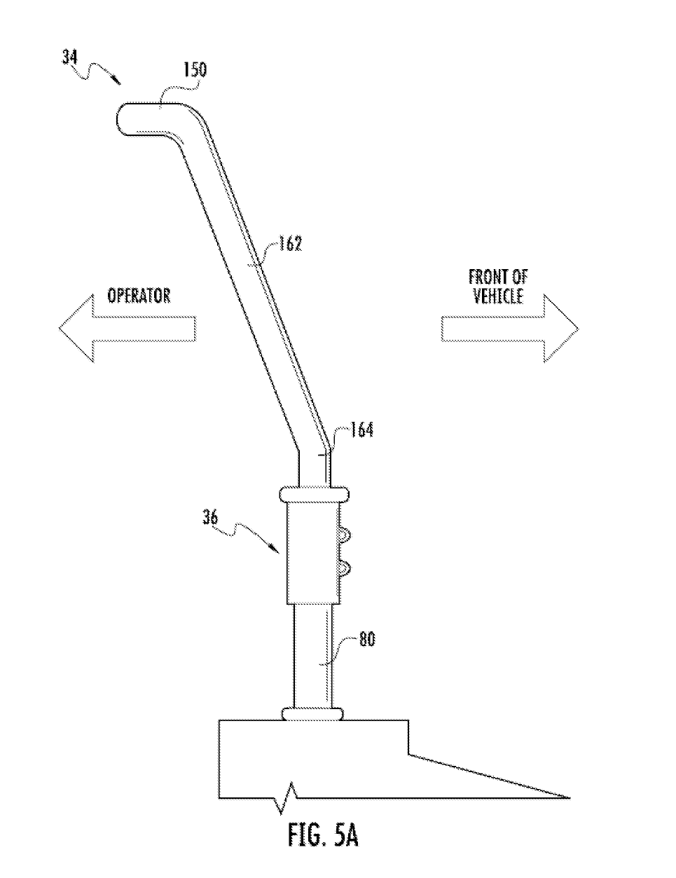

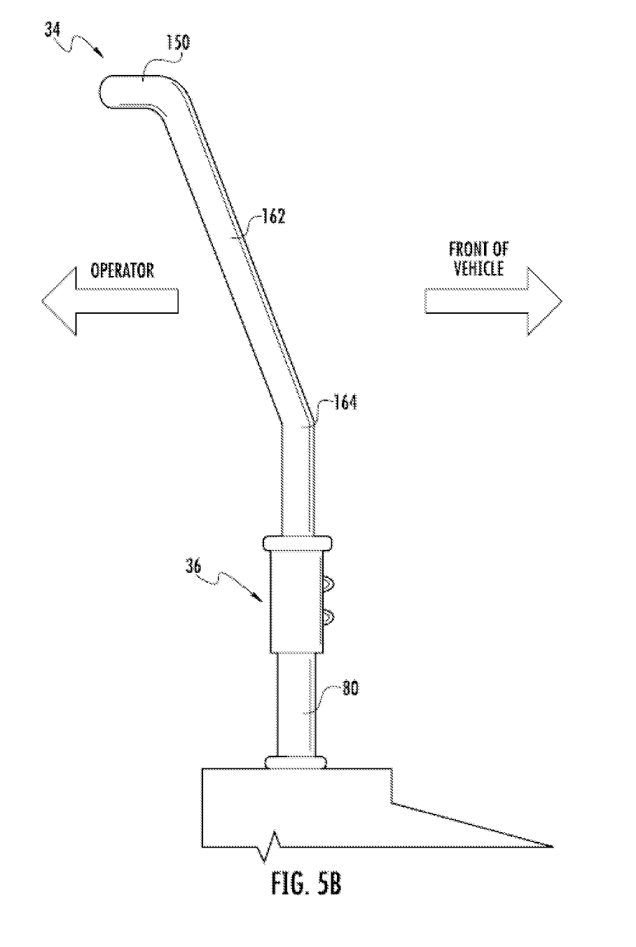

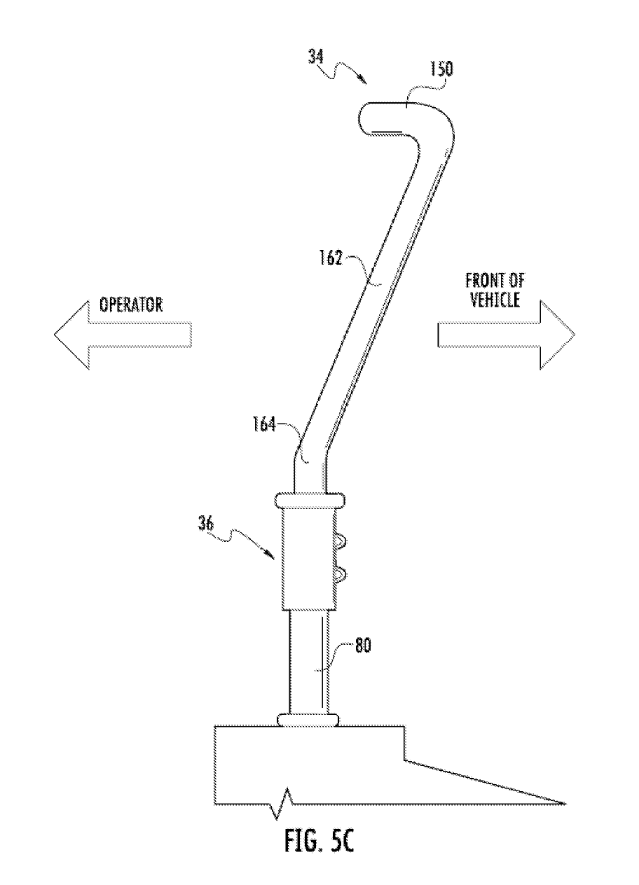

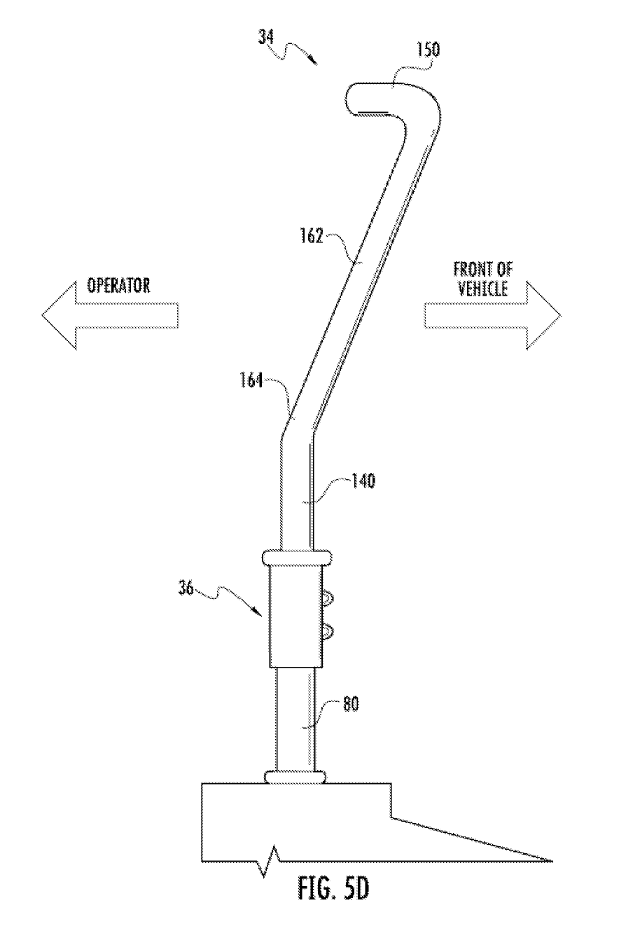

FIGS. 2-5 illustrate more detailed views of some portions of the steering assembly 30 to illustrate an example embodiment. In this regard, FIG. 2 illustrates a perspective view of the steering assembly 30 with the steering levers 34 being pulled back for rearward propulsion according to an example embodiment. FIG. 3 illustrates a perspective view of the vertical adjustment assembly 36 according to an example embodiment. FIG. 4, which includes FIGS. 4A and 4B, illustrates a perspective view of the steering levers 34 to illustrate the bent nature of the steering levers 34 that facilitates lever swapping to provide easy adjustment of the distance from the steering levers 34 to the operator according to an example embodiment. FIG. 5, which includes FIGS. 5A, 5B, 5C and 5D, illustrates the steering levers 34 in each of four different positions according to various example embodiments.

Referring now to FIGS. 2-5, the steering assembly 30 may include steering levers 34. In an example embodiment, the steering levers 34 may each be removably and adjustably connected to a base bar 80 via the vertical adjustment assembly 36. The base bar 80 may be operably connected to drive components such as a hydraulic motor for providing drive power to one of the wheels based on a position of the corresponding one of the steering levers 34. In some examples, the base bar 80 and the steering levers 34 may each be cylindrical tubes or rods made of metallic, composite or other rigid materials. However, other shapes may also be employed (e.g., a rectangular, hexagonal or square shaped cross section).

In an example embodiment, the vertical adjustment assembly 36 may also be made of a metallic, composite or other rigid material, which may be the same or a different material than that used for either or both of the steering levers 34 and the base bar 80. Moreover, in some embodiments, at least a portion of the vertical adjustment assembly 36 may be a unitary piece of material with a corresponding portion of the base bar 80. In other embodiments, the vertical adjustment assembly 36 may slide or otherwise fit over an end of the base bar 80 and may be affixed thereto. For example, as shown in FIG. 3, the vertical adjustment assembly 36 may include a main body 100 that may be affixed to the base bar 80 by frictional engagement via a clamp that may be tightened using clamp screws 102 and/or by being screwed or riveted to the base bar 80 via screw or rivet receivers 104.

In an example embodiment, the main body 100 may further include or otherwise be attached to a clamping device 110. The clamping device 110 may be provided to releasably engage a corresponding one of the steering levers 34. In this example, the clamping device is a “chuck” style clamp. However, other clamping devices could be employed in some alternative embodiments. The clamping device 110 may include a thread receiver 112, a threaded cap 114 and one or more slots 116 that separate a first clamp portion 118 and a second clamp portion 120. The threaded cap 114 may also include threads 122 configured to more tightly engage the thread receiver 112 responsive to rotation of the threaded cap 114 in a first direction. Additionally, the threaded cap 114 may be configured to loosen the engagement with the thread receiver 112 to the point of potential disengagement responsive to rotation of the threaded cap 114 in a second direction that is opposite of the first direction.

In some embodiments, the first and second clamp portions 118 and 120 may substantially define a geometric shape that matches the shape of the steering levers 34, or at least a cross section shape of a bottom portion 140 of each of the steering levers 34. Thus, for example, in cases where the bottom portion 140 is a cylindrical rod or tube having a circular cross section, the first and second clamp portions 118 and 120 may combine to form a tube (or portion thereof) with a circular cross section as well. The one or more slots 116 may divide the first and second clamp portions 118 and 120 from each other. In other words, the one or more slots 116 may define gaps between the first and second clamp portions 118 and 120. The one or more slots 116 may extend along a line parallel to a longitudinal centerline of the main body 100 inward from an edge of the clamping device 110 in some cases. However, in other example embodiments, the one or more slots 116 may extend diagonally or unevenly inward from the edge of the clamping device 110. In some cases, the one or more slots 116 may advance from the edge of the clamping device 110 inwardly beyond the thread receiver 112, as shown in FIG. 3.

Because the one or more slots 116 separate the first and second clamp portions 118 and 120, the first and second clamp portions 118 and 120 may be enabled to move toward each other to frictionally engage an object therebetween (e.g., the bottom portion 140) responsive to exertion of a force or forces directing the first and second clamp portions 118 and 120 toward each other. In an example embodiment, the thread receiver 112 may be configured such that subsequently lower threads (or more inwardly disposed threads relative to an edge of the clamping device 110) may have a slightly larger circumference than higher (or more outwardly disposed) threads. In other words, the outer diameter of the thread receiver 112 may increase as distance from the edge of the clamping device 110 increases.

The threaded cap 114 may be configured such that the threads 122 disposed therein engage the thread receiver 112 and tighten thereupon responsive to rotation of the threaded cap 114 in the first direction. Based on such movement, the threaded cap 114 may subsequently engage more inwardly disposed threads of the thread receiver 112 as the threaded cap 114 is tightened to thereby draw the first and second clamp portions 118 and 120 toward one another. In situations where the bottom portion 140 is disposed between the first and second clamp portions 118 and 120, the tightening of the threaded cap 114 may increase the amount of frictional engagement between the first and second clamp portions 118 and 120 and the bottom portion 140 to hold the bottom portion 140 in fixed engagement with the vertical adjustment assembly 36 and therefore also with the base bar 80.

In some embodiments in which the bottom portion 140 is a cylindrical rod or tube, the first and second clamp portions 118 and 120 may combine to have a cross section having a circular shape with an internal diameter (e.g., a diameter measured between respective internal surfaces of the first and second clamp portions 118 and 120) slightly larger than the external diameter of the bottom portion 140 (e.g., diameter measured between respective outside surfaces of the bottom portion 140). Moreover, the external diameter of the bottom portion 140 may also be slightly less than the internal diameter of the base bar 80. Thus, for example, the bottom portion 140 may be enabled to telescopically be inserted, or collapse, into the vertical adjustment assembly 36 (e.g., between the first and second clamp portions 118 and 120) and the base bar 80 to at least some degree when the first and second clamp portions 118 and 120 are in a relaxed state (e.g., when the threaded cap 114 is not tightened onto the thread receiver 112). The bottom portion 140 may alternatively be withdrawn to any desired height and the position of the bottom portion 140 relative to the base bar 80 may be fixed accordingly by tightening the threaded cap 114 onto the thread receiver 112.

FIG. 4 illustrates two perspective views of one of the steering levers 34 according to an example embodiment. As can be appreciated from FIG. 4, the steering lever 34 includes two distal ends opposite to one another including a first end 142 and a second end 144. In an example embodiment, the bottom portion 140 may define a portion of the steering lever 34 that is proximate to the first end 142 of the steering lever 34 as shown in FIG. 4. The second end 142 of the steering lever 34 may be positioned at the end of a handle portion 150 of the steering lever 34. The handle portion 150 may extend from the second end 142 to a handle bend 152. The handle bend 152 may be a bent portion defining a gradual bend of approximately ninety degrees to a lever shaft 160 that may include an upper portion 162 and the bottom portion 140. Thus, for example, the handle bend 152 may separate the handle 150 from the lever shaft 160, or more specifically, separate the handle 150 from the upper portion 162 of the lever shaft 160.

In an example embodiment, the upper portion 162 of the lever shaft 160 may extend in a direction substantially perpendicular to a direction of extension of the handle 150. However, in some embodiments the lever shaft 160 need not extend perpendicular to the direction of extension of the handle 150. In any case, the upper portion 162 and the handle 150 may each lie in a same plane as can be appreciated from FIG. 4A, which shows a view looking down the plane in which the upper portion 162 and the handle 150 lie. The upper portion 162 may extend from the handle bend 152 to a shaft bend 164 that separates the upper portion 162 from the bottom portion 140. As can be seen in FIG. 4, the shaft bend 164 directs the bottom portion 140 to extend out of the plane in which the upper portion 162 and the handle lie 150. The angle of the shaft bend 164 may be relatively small in some embodiments (e.g., from about 5 degrees to about 20 degrees). However, in some embodiments, the angle may be selected to be at least of sufficient magnitude to prevent or inhibit telescopic or collapsible insertion of the lever shaft 160 (at least the bottom portion 140 thereof) into the base bar 80 and the vertical adjustment assembly 36 beyond the shaft bend 164. Maximum values for the angle may be determined based on the practical limits for providing rider comfort when swapping the orientation of the steering levers 34 by physically swapping the pairings of the steering levers 34 and respective ones of the base bars 80.

As can be appreciated from the description above, the bottom portion 140 may be telescopically inserted into the base bar 80 and the vertical adjustment assembly 36 to enable adjustments to be made to the height of the steering levers 34. As shown in FIGS. 1 and 2, the handles 150 of the steering levers 34 generally point toward each other and the second ends thereof are relatively close to one another. The proximity of the steering levers 34 to each other may make the employment of matching height adjustments a relatively easy task to undertake. However, to further facilitate height matching, the bottom portion 140 of each of the steering levers 34 may include height markings in some cases. Thus, for example, the bottom portions 140 of each of the steering levers 34 may be inserted into its corresponding vertical adjustment assembly 36 to a specific height marking, and then the bottom portions 140 may be affixed at the height corresponding to the specific height marking via tightening of the threaded cap 114 of the corresponding clamping device 110.

Accordingly, some example embodiments may enable steering lever height adjustments to be made relatively quickly and easily using a telescoping shaft and a clamping device that can clamp the telescoping shaft in place at a selected height. However, some example embodiments may additionally or alternatively enable orientation adjustments with respect to the positioning of the steering levers 34. In this regard, although the typical configuration of the steering levers 34 is to place the second ends thereof (e.g., second end 144) proximate to each other and directly in front of the operator, the operator may rotate the orientation of the steering levers and then tighten them in position using the clamping device 110. Although any orientation including a full 360 degree rotation of the steering lever 34 is theoretically possible, some embodiments may provide the shaft bend 164 to be at a selected angle that provides two main options for handle placement relative to the operator based on the orientation of the steering levers 34. Both options may provide for second ends of the steering levers 34 to be proximate to each other during operation. In this regard, for example, in a first steering lever positioning option, the steering levers 34 may be inserted into respective base bars 80 on opposite sides of the riding lawn care vehicle 10 such that the shaft bend 164 directs the handles 150 of each of the steering levers 34 toward the operator. Meanwhile, in a second steering lever positioning option, the steering levers 34 may be swapped in relation to with which base bar 80 each steering lever 34 is paired. By swapping the steering levers 34, the shaft bend 164 may direct the handles 150 of each of the steering levers 34 away from the operator.

FIG. 5, which includes FIGS. 5A, 5B, 5C and 5D, illustrates various examples of different configurations of the steering levers based on respective different employment options. FIG. 5A illustrates a perspective view of a lowered-first steering lever positioning option where the shaft bend 164 is oriented to direct the handles 150 toward the operator, and the bottom portion 140 is substantially fully inserted into the base bar 80 and the vertical adjustment assembly 36. FIG. 5B illustrates a perspective view of an elevated-first steering lever positioning option where the shaft bend 164 still directs the handles 150 toward the operator, but the bottom portion 140 is extended to provide a higher handle elevation. FIG. 5C illustrates a perspective view of a lowered-second steering lever positioning option where the shaft bend 164 is oriented to direct the handles 150 away from the operator, and the bottom portion 140 is substantially fully inserted into the base bar 80 and the vertical adjustment assembly 36. FIG. 5D illustrates a perspective view of an elevated-second steering lever positioning option where the shaft bend 164 still directs the handles 150 away from the operator, but the bottom portion 140 is extended to provide a higher handle elevation.

It should be appreciated that some embodiments of the invention, such as those illustrated herein, are configured such that an operator may be able to adjust the steering levers of a steering assembly relatively easily by hand and without the use of external tools. The adjustment may, in many cases, be made while the operator remains seated on a riding lawn care vehicle employing an example embodiment. In this regard, some embodiments may enable a height of the steering levers to be adjusted for operator comfort, and/or the steering levers may be oriented such that the levers are positioned to extend the handles closer to, or farther from, the operator. Although the examples described herein illustrate and explain some structural implementations, other example implementations are also possible.

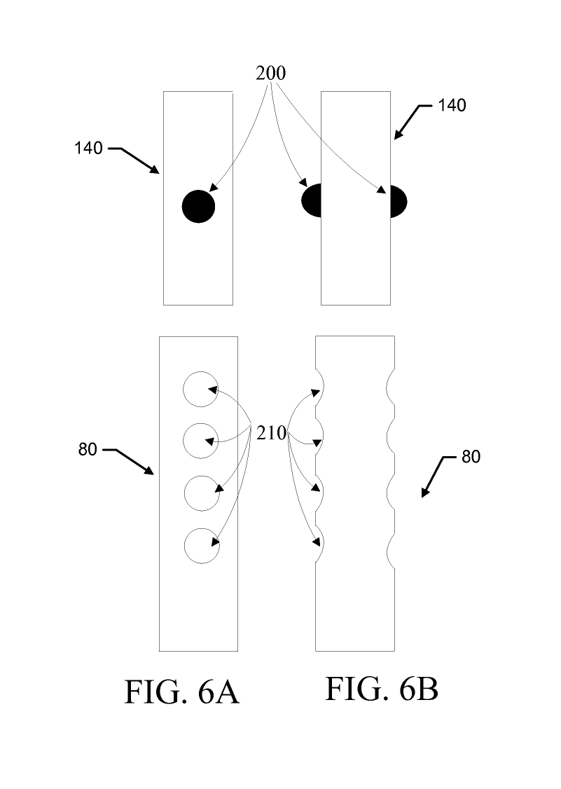

FIG. 6, which includes FIGS. 6A and 6B, illustrates a further alternative embodiment of a vertical adjustment assembly 36. In this embodiment, the bottom portion 140 may include one or more operably mounted, spring-loaded detents 200 or protrusions. The vertical adjustment assembly 36 may also include at least one set of detent receivers 210 spaced apart so as to match a corresponding position of the detents 200 on the bottom portion 140. In some embodiments, the detent receivers 210 may be disposed directly in the base bar 80. However, in other embodiments, the vertical adjustment assembly 36 may include a separate portion or piece including the detent receivers 210 that may be attached to the base bar 80. To adjust the height of the steering lever 34, the operator may depress the detents 200 to a point where the detents 200 do not impede movement of the bottom portion 140 within the base bar 80 (or vertical adjustment assembly 36). In other words, the cross section of the bottom portion 140 including the detents 200 may be equal or less than the cross section of the vertical adjustment assembly 36 and base bar 80. The operator may therefore be enabled to slide the bottom portion 140 into the vertical adjustment assembly 36 (or base bar 80). When the steering lever 34 is at the desired height the user can adjust the rotation of the bottom portion 140 such that the detents 200 are operably lined up with the corresponding detent receivers 202. The spring-loaded detents 200 may then spring or push outward and protrude out of the detent receivers 210 to lock the steering lever 34 in place. Having multiple sets (greater than one set) of detent receivers 210 at incremental vertical heights allows a degree of availability of height adjustments that is proportional to the number of sets of detent receivers 210 provided.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A riding lawn care vehicle comprising:
a frame to which wheels of the riding lawn care vehicle are attachable; and
a steering assembly operably coupled to at least two drive wheels of the riding lawn care vehicle to facilitate turning of the riding lawn care vehicle based on drive speed control of the at least two drive wheels responsive to positioning of steering levers of the steering assembly,
wherein the steering assembly includes a vertical adjustment assembly configured to enable telescopic adjustment of a height of a corresponding one of the steering levers.

2. The riding lawn care vehicle of claim 1, wherein the vertical adjustment assembly includes a clamping device affixed to a base bar of the steering assembly, the base bar being operably coupled to a corresponding one of the at least two drive wheels, the clamping device enabling increased frictional engagement to be applied to at least a portion of the corresponding one of the steering levers to fix the height of the corresponding one of the steering levers.

3. The riding lawn care vehicle of claim 2, wherein a diameter of the clamping device and the base bar is greater than a diameter of a lever shaft of the corresponding one of the steering levers.

4. The riding lawn care vehicle of claim 3, wherein the clamping device includes a threaded cap tightenable to a thread receiver to fix a position of the lever shaft relative to the clamping device.

5. The riding lawn care vehicle of claim 4, wherein the clamping device attaches to the base bar at one end thereof and the clamping device includes one or more slots defining first and second clamp portions at an opposite end thereof, the thread receiver being disposed over the first and second clamp portions to draw the first and second clamp portions toward each other responsive to tightening of the threaded cap to the thread receiver.

6. The riding lawn care vehicle of claim 1, wherein each of the steering levers includes a handle portion and a lever shaft, the lever shaft of at least one of the steering levers being telescopically insertable into a clamping device affixed to a base bar of the steering assembly, the base bar being operably coupled to a corresponding one of the at least two drive wheels, the clamping device enabling increased frictional engagement to be applied to at least a portion of the lever shaft to fix the height of the corresponding one of the steering levers.

7. The riding lawn care vehicle of claim 6, wherein the lever shaft includes an upper shaft portion and a bottom shaft portion separated by a shaft bend, the upper shaft portion lying in a plane with the handle portion and extending substantially perpendicular to the handle portion, the bottom shaft portion extending away from the shaft bend out of the plane.

8. The riding lawn care vehicle of claim 7, wherein the bottom shaft portion is insertable into the clamping device, and a height of the corresponding one of the steering levers is adjustable based on an amount of the bottom shaft portion that is inserted into the clamping device.

9. The riding lawn care vehicle of claim 7, wherein an orientation of the bottom shaft portion is adjustable within the clamping device.

10. The riding lawn care vehicle of claim 9, wherein the orientation of the bottom shaft portion is adjustable over at least two positions including a first position in which the shaft bend is oriented such that the upper shaft portion extends toward an operator of the riding lawn care vehicle and a second position in which the shaft bend is oriented such that the upper shaft portion extends away from the operator of the riding lawn care vehicle.

11. The riding lawn care vehicle of claim 1, wherein the riding lawn care vehicle is a zero turn radius mower.

12. The riding lawn care vehicle of claim 1, wherein the vertical adjustment assembly includes one or more detent receivers disposed at fixed vertical positions relative to a base bar of the steering assembly, the base bar being operably coupled to a corresponding one of the at least two drive wheels, the one or more detent receivers being disposed to engage at least one corresponding detent disposed on a portion of the corresponding one of the steering levers to fix the height of the corresponding one of the steering levers responsive to insertion of the at least one corresponding detent within one of the one or more detent receivers.

13. An adjustable steering assembly for employment on a riding lawn care vehicle, the adjustable steering assembly comprising:
a pair of independently operable steering levers;
a corresponding pair of base bars operably coupled to respective ones of the steering levers and operably coupled to respective ones of at least two drive wheels of the riding lawn care vehicle to facilitate turning of the riding lawn care vehicle based on drive speed control of the at least two drive wheels responsive to positioning of the steering levers,
wherein each one of the steering levers includes a vertical adjustment assembly configured to enable telescopic adjustment of a height of a corresponding one of the steering levers.

14. The adjustable steering assembly of claim 13, wherein the vertical adjustment assembly includes a clamping device affixed to a corresponding one of the base bars, the clamping device enabling increased frictional engagement to be applied to at least a portion of the corresponding one of the steering levers to fix the height of the corresponding one of the steering levers.

15. The adjustable steering assembly of claim 14, wherein a diameter of the clamping device and the corresponding one of the base bars is greater than a diameter of a lever shaft of the corresponding one of the steering levers.

16. The adjustable steering assembly of claim 15, wherein the clamping device includes a threaded cap tightenable to a thread receiver to fix a position of the lever shaft relative to the clamping device.

17. The adjustable steering assembly of claim 16, wherein the clamping device attaches to the corresponding one of the base bars at one end thereof and the clamping device includes one or more slots defining first and second clamp portions at an opposite end thereof, the thread receiver being disposed over the first and second clamp portions to draw the first and second clamp portions toward each other responsive to tightening of the threaded cap to the thread receiver.

18. The adjustable steering assembly of claim 13, wherein each of the steering levers includes a handle portion and a lever shaft, the lever shaft of at least one of the steering levers being telescopically insertable into a clamping device affixed to a corresponding one of the base bars, the clamping device enabling increased frictional engagement to be applied to at least a portion of the lever shaft to fix the height of the corresponding one of the steering levers.

19. The adjustable steering assembly of claim 18, wherein the lever shaft includes an upper shaft portion and a bottom shaft portion separated by a shaft bend, the upper shaft portion lying in a plane with the handle portion and extending substantially perpendicular to the handle portion, the bottom shaft portion extending away from the shaft bend out of the plane.

20. The adjustable steering assembly of claim 19, wherein the bottom shaft portion is insertable into the clamping device, and a height of the corresponding one of the steering levers is adjustable based on an amount of the bottom shaft portion that is inserted into the clamping device.

21. The adjustable steering assembly of claim 19, wherein an orientation of the bottom shaft portion is adjustable within the clamping device.

22. The adjustable steering assembly of claim 21, wherein the orientation of the bottom shaft portion is adjustable over at least two positions including a first position in which the shaft bend is oriented such that the upper shaft portion extends toward an operator of the riding lawn care vehicle and a second position in which the shaft bend is oriented such that the upper shaft portion extends away from the operator of the riding lawn care vehicle.

23. The adjustable steering assembly of claim 13, wherein the vertical adjustment assembly includes one or more detent receivers disposed at fixed vertical positions relative to a base bar of the steering assembly, the base bar being operably coupled to a corresponding one of the at least two drive wheels, the one or more detent receivers being disposed to engage at least one corresponding detent disposed on a portion of the corresponding one of the steering levers to fix the height of the corresponding one of the steering levers responsive to insertion of the at least one corresponding detent within one of the one or more detent receivers.
